(19) United States
(12) Patent Application Publication
(10) Pub. No.: US 2023/0129105 A1
(43) Pub. Date: Apr. 27, 2023

(54) AUTOMATIC DETERMINATION OF INTELLECTUAL CAPITAL GAPS

(71) Applicant: Cisco Technology, Inc., San Jose, CA (US)

(72) Inventors: Magnus Mortensen, Cary, NC (US); Jay Kemper Johnston, Raleigh, NC (US); David C. White, Jr., St. Petersburg, FL (US)

(21) Appl. No.: 17/512,023

(22) Filed: Oct. 27, 2021

(51) Int. Cl. G06Q 10/06

(52) U.S. Cl. CPC G06Q 10/063112

(57) ABSTRACT

A support server identifies and closes a gap in the coverage of existing Intellectual Capital (IC) modules. The support server obtains issue data from support cases including issue description data, diagnostic data, and resolution data for a particular support case. The support server separates the support cases into issue groups based on a similarity in the issue data. The support server associates a relevant IC module with one or more covered issue groups among the issue groups based on a majority of the support cases in the one or more issue groups including an indication of the relevant IC module in the issue data. The support server selects an uncovered issue group from the issue groups other than the one or more covered issue groups, and determines a new IC module to resolve support cases in the uncovered issue group.

### TECHICAL FIELD

The present disclosure relates to intellectual capital systems.

### BACKGROUND

Creating Intellectual Capital (IC) to power an analytics system typically consumes a huge amount of human effort, particularly from Subject Matter Experts (SMEs). The SMEs read through text descriptions of issues and the resolutions of the issues to determine and write an IC module that resolves each issue. Support technician and engineers may use the IC modules to resolve an issue more quickly when the same issue occurs, e.g., for a different user. The IC modules may be written as machine readable modules that automatically resolve issue commonly encountered by users. Alternatively, an IC module may be human consumable (e.g., documentation) that enables a user to resolve the issue. The analytics systems may use text classification and natural language processing to automatically determine an appropriate IC module for a specific issue.

### BRIEF DESCRIPTION OF THE DRAWINGS

FIG. 1 is a system diagram a support server configured to determine gaps in the coverage of existing IC modules, according to an example embodiment.

FIG. 2 is a message flow diagram illustrating messages exchanged in resolving a user issue and preparing the support server to determine gaps in IC module coverage, according to an example embodiment.

FIG. 3 is a flowchart illustrating operations performed at a support server to resolve user issues and store data related to unresolved issues, according to an example embodiment.

FIG. 4 is a flowchart illustrating operations performed at a support server to automatically generate a new IC module that fills a gap in the coverage of existing IC modules, according to an example embodiment.

FIG. 5 is a diagram illustrating clustering of issue data used in determining gaps in the coverage of existing IC modules, according to an example embodiment.

FIG. 6 illustrates an issue group that is associated with an IC module that is expected to resolve the issues in the issue group, according to an example embodiment.

FIG. 7 illustrates an issue group that is not associated with an existing IC module, according to an example embodiment.

FIG. 8 is a flowchart illustrating operations performed at a support server to automatically detect gaps in the coverage of existing IC modules, according to an example embodiment.

FIG. 9 is a hardware block diagram of a computing device that may perform functions associated with any combination of operations discussed herein in connection with the techniques depicted in FIGS. 1-8.

### DESCRIPTION OF EXAMPLE EMBODIMENTS

### Overview

A computer-implemented method is provided for a support server to identify and close a gap in the coverage of existing IC modules. The method includes obtaining issue data from a plurality of support cases. The issue data from a particular support case of the plurality of support cases includes issue description data, diagnostic data, and resolution data associated with the particular support case. The method also includes separating the plurality of support cases into a plurality of issue groups based on a similarity in the issue data. The method further includes associating a relevant IC module with one or more covered issue groups among the plurality of issue groups based on a majority of the support cases in the one or more issue groups including an indication of the relevant IC module in the issue data. The method also includes selecting an uncovered issue group from the plurality of issue groups other than the one or more covered issue groups and determining a new IC module to resolve support cases in the uncovered issue group.

### Example Embodiments

The human capital in generating Intellectual Capital (IC) modules for an issue management system may be expensive and may be used most effectively when targeted to resolve issues with larger impact. In other words, the most efficient improvement to the issue management system lies in directing the time and resources to developing IC modules that resolves the most impactful issues that occur the most. Additional Subject Matter Expert (SME) oversight is typically needed to identify the high volume, high impact issues to resolve and maximize the return on investment of human capital. The techniques presented herein leverage machine learning and natural language processing to automatically determine the areas in which there are gaps in the coverage of IC modules. Additionally, the system may also identify the scale of the IC gaps and the potential impact of closing the existing IC gaps by developing a new IC module.

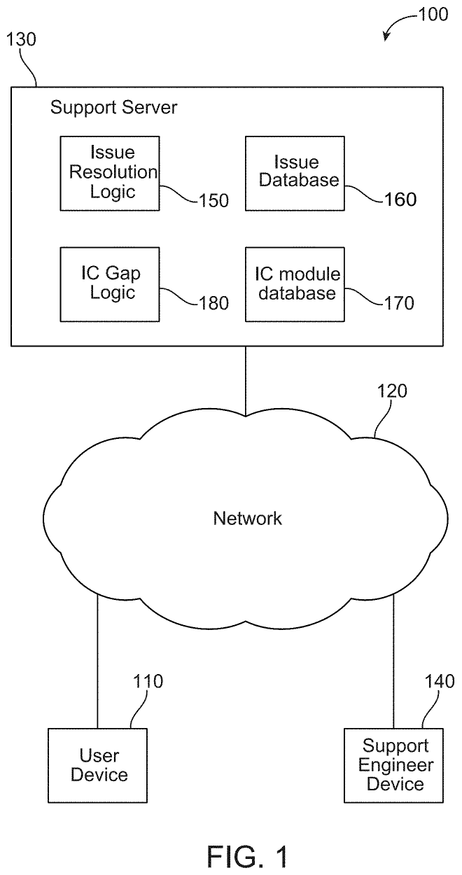

Referring now to FIG. 1, a simplified block diagram shows an issue resolution system 100 configured to resolve issues in a user device 110. The user device 110 is connected through a network 120 to a support server 130. Additionally, a support engineer device 140 is connected to the network. In one example, the computing devices (e.g., user device 110, support server 130, and support engineer device 140) may be a personal computing device (e.g., laptop computer, desktop computer, tablet computer, smart phone, etc.) or a general use computing device (e.g., server, network device, Internet of Things (IoT) device, embedded device, etc.). In another example, the network 120 may include one or more computer networks (e.g., Local Area Network (LAN), Virtual LAN (VLAN), Wide Area Network (WAN) (e.g., the Internet), Software Defined WAN (SD-WAN), Wireless Local Area Network (WLAN), Wireless Wide Area Network (WWAN), Metropolitan Area Network (MAN), Intranet, Extranet, Virtual Private Network (VPN), Low Power Network (LPN), Low Power Wide Area Network (LPWAN), Machine to Machine (M2M) network, IoT network, Ethernet network/switching system, etc.).

The support server 130 may comprise one or more computing devices including issue resolution logic 150, issue database 160, IC module database 170 and IC gap logic 180. In one example, the support server 130 may include separate devices for one or more of the components (e.g., issue database 160 and IC module database) that are communicatively coupled. The separate devices may be communicatively coupled through the network 120 or through one or more additional connections.

The issue resolution logic 150 enables the support server 130 to process issues submitted by the user device 110. For instance, the issue resolution logic 150 may enable the support server 130 to determine one or more IC modules that would be applicable to an issue. The support server 130 also includes an issue database 160 that stores information associated with issues submitted by users in support requests. In one example, the issue database 160 may store description data, diagnostic data, and resolution data for each support case.

The IC module database 170 stores IC modules configured to resolve various issues reported by various users. For instance, the IC module database 170 may store an IC module that identifies a resolution (e.g., upgrade firmware to version 12) for a specific issue (e.g., Network Address Translation (NAT) logic drops authorized traffic) for a particular type of device (e.g., a network router). The IC modules stored in the IC module database 170 may be machine consumable and running the IC module resolves an issue without additional human intervention. Alternatively, the IC modules may be human consumable, e.g., the IC module directs the user to read documentation steps that will resolve the issue when the user performs the steps.

The IC gap logic 180 enables the support server 130 to analyze the issues stored in the issue database 160 and the IC modules stored in the IC module database 170 to determine any gaps in the coverage of the IC modules. In one example, the IC gap logic 180 may cluster support cases with related issues into issue groups and determine that no single IC module is associated with the resolution of most or all of the support cases in the issue group. In another example, the IC gap logic 180 notify a Subject Matter Expert (SME) of the potential for closing the IC coverage gap with a new IC module. Alternatively, the IC gap logic 180 may enable the support server 130 to automatically generate a new IC module configured to resolve the issues in one of the issue groups. Additionally, the IC gap logic 180 may prioritize the issue groups based on attributes of the issue group (e.g., the number of support cases clustered into the issue group, the impact of the issues in the issue group, etc.). The IC gap logic 180 may include Machine Learning (ML) logic to cluster the support cases into the issue groups and/or to determine whether an existing IC module effectively covers the issue group or whether a new IC module may provide more effective resolutions for the issue group.

In one example, the techniques described herein solve the challenging task of IC gap identification through analysis of alerts generated by an IC analysis engine and classification of the associated support requests through ML based clustering. A typical support engagement for a user may begin with the user opening a support case and describing the issue. The IC analysis engine gathers diagnostic data, which may be analyzed by both automated systems and human support engineers. For instance, the issue resolution logic 150 may select one or more IC modules from the IC module database 170 that may be relevant to the issue described by the user, and the support engineer may determine whether one or more of the selected IC modules is likely to resolve the issue.

As a result of the analysis, either the user or the support engineer may take mitigation actions. For instance, the analysis results may notify the user to perform a mitigation action (e.g., restart the user device 110, adjust a setting in the user device 110, download and install an update for the user device 110, etc.). Alternatively, a support engineer may perform the mitigation actions on behalf of the user and/or perform additional mitigation actions that may be unavailable to the user (e.g., updating settings in the network 120). Once the issue is resolved through the mitigation actions, the user or the support engineer may close the support case. The IC gap logic 180 enables the support server 130 to automatically find gaps in the coverage of the IC modules stored in IC module database 170 by hooking into the issue resolution process in multiple locations.

During the lifestyle of a support case, a user may provide varying amounts of diagnostic data, which will be analyzed, provided to a support engineer, and stored in the issue database 160 for later use and retrieval. The issue data stored in the issue database 160 may include an outline of a specific issue as well as steps for remediating that specific issue. For instance, the issue data may include bug or defect identifiers, links, or other key items for resolving the specific issue. If the information provided by the user was relevant to the resolution of the user's issue, case notes included in the issue data will document information from any discussion between the user and the support engineer assigned to the support case. The support server 130 may leverage text similarity calculations (e.g., cosine similarities) on information stored in the issue database 160 to determine if an issue outlined in a future request for support.

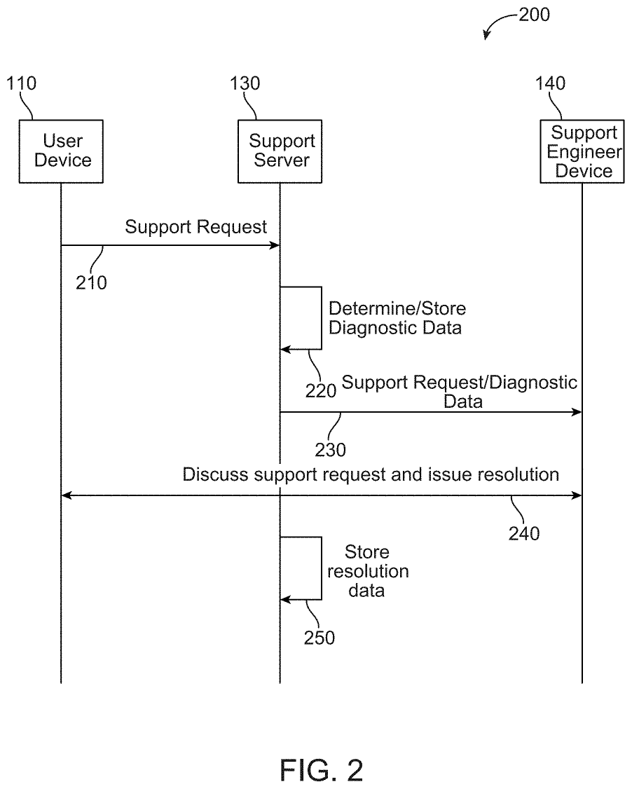

Referring now to FIG. 2, a message flow diagram illustrates a process 200 for resolving a support case, which may be used to provide data for the support server 130 to determine gaps in the coverage of existing IC modules. Initially, the user device 110 sends a support request 210 to the support server 130. In one example, the support request 210 includes a description of an issue (e.g., text description entered by a user of the user device 110) and may include additional diagnostic data (e.g., configuration data of the user device 110). The support server 130 may determine additional diagnostic data and store the diagnostic data at 220. In one example, the support server 130 may automatically parse the support request 210 to identify one or more issues and/or IC modules related to the identified issues.

The support server 130 provides a message 230 to the support engineer device 140. The message 230 may include issue description data (e.g., the text description entered by the user of the user device 110) and/or diagnostic data collected form the user device 110 or automatically determined at the support server 130. A support engineer using the support engineer device 140 may initiate a conversation 240 with the user of the user device 110 to obtain additional information and discuss potential steps to resolve the issue reported by the user device 110. Once the issue is resolved, the support server 130 may store resolution data 250 for future reference. In one example, the resolution data 250 may include an indication of an IC module that resolved the reported issue.

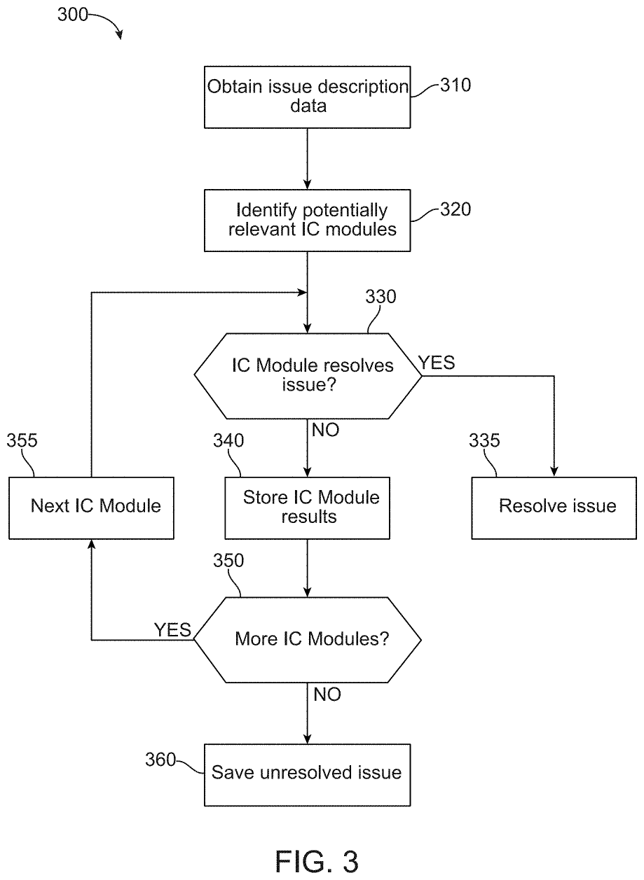

Referring now to FIG. 3, a flowchart illustrates operations performed by a support server (e.g., support server 130) in a process 300 for identifying the coverage of IC modules. At 310, the support server obtains issue description data. In one example, the issue description data may be a text-based description of an issue with a user device as part of a support request. At 320, the support server identifies potentially relevant IC modules. In one example, the support server may automatically parse the text of the issue description data to select one or more potentially relevant IC modules that may resolve the issue. In another example, a support engineer may work with the support server to obtain additional issue description data or other diagnostic data from the user. Additionally, the support engineer may adjust the set of potentially relevant IC modules selected by the support server based on their analysis of the issue description data, diagnostic data, and interactions with the user.

At 330, one of the potentially relevant IC modules is tested to determine whether the IC module resolves the issue reported by the user. In one example, the IC module may be machine consumable and automatically implement a resolution on the user device. Alternatively, the IC module may present human readable remediation steps for the user and/or the support engineer to follow. If the IC module resolves the issue, then the support server resolves the issue at 335. In one example, the support server may store resolution data for the support case that associates the IC module with the issue data (e.g., the issue description data and the diagnostic data).

If the IC module does not resolve the issue, as determined at 330, then the support server stores the IC module results at 340 for further analysis by the support server and/or the support engineer. At 350 the support server determines whether another potentially relevant IC module remains to be tested. If the support server has identified additional IC modules, then the next IC module is selected at 355 and the process returns to 330 to determine whether the next IC module resolves the issue. If there are no more potentially relevant IC modules to test, as determined at 350, then the support server stores the issue as an unresolved issue at 360.

In one example, the process 300 may be described as a wormhole that is created to work through a family of issues on a user device. The wormhole includes an issue detection engine that runs and detects symptoms indicative of an issue and enters a decision tree, which compares known issues that may result in the detected symptom. The wormhole analyzes data from the user device at each step in the decision tree, testing for conditions and remediation effects. By the end of the wormhole, the support server has either determined the root cause of the issue (e.g., at 335) or saved that instance of the issue (e.g., at 360) along with all of the data analyzed at each step in the decision tree. The support server saves the data from the unresolved issues for later analysis.

In a specific example, a wormhole may include multiple nodes that each check for a specific known issue that results in the same symptom. For instance, a symptom of an issue may be that an application on the user device is not being automatically updated. A first node in the wormhole may determine if Domain Name System (DNS) resolution is properly enabled. If the first node determines that DNS resolution is not enabled, an associated IC module may provide remediation steps to enable DNS. If the first node determines that DNS is properly enabled, the second node of the wormhole may determine whether the license for the application is valid. If the license for the application is not valid, then an associated IC module may provide instructions to renew the application license. Once one of the nodes in the wormhole determines the root cause of the issue, the wormhole ends and the support case may be closed and saved for future reference. The wormhole may be expanded to any length, based on the number of known issues that would result in the reported symptom.

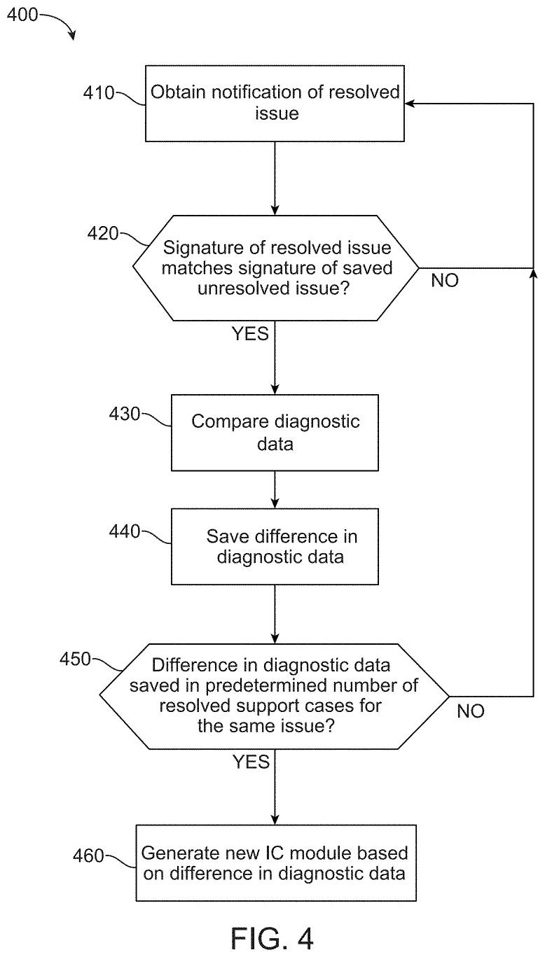

Referring now to FIG. 4, a flowchart illustrates operations performed by a support server (e.g., support server 130) in a process 400 to automatically generate a new IC module based on a set of resolved issues. At 410 the support server obtains a notification of a resolved issue. In one example, the notification may be obtained from the user device or the support engineer device. If the support server determines that the signature of the resolved issue does not match the signature of any saved unresolved issues, as determined at 420, then the process 400 returns to wait for more issues to be resolved. In one example, the signature of the resolved issue may include issue description data and/or diagnostic data.

If the signature of the resolved issue does match the signature of an unresolved issue that has been previously saved, then the support server compares the diagnostic data from the previously saved, unresolved issue and the resolved issue associated with the notification at 430. The support server saves the difference in diagnostic data at 440 as, for instance, issue resolution data. Once the support server has saved enough instances (e.g., more than a predetermined number) of resolved support cases with the same calculated difference in diagnostic data for the same issue, as determined at 450, the support server generates a new IC module based on that calculated difference at 460. For instance, once a predetermined number of different user devices (e.g., fifty user devices) have reported the support cases with a particular issue and all of the support cases have been resolved such that the difference in diagnostic data from all of the user devices is the same, then the support server may automatically generate an IC module that resolves the particular issue based on remediation steps that lead to the calculated difference in diagnostic data.

In one example, the support server may automatically extend the wormhole to generate additional nodes and associated IC modules based on the resolution of issues. The support server may generate a new identifier for an unresolved issues and store issue data (e.g., description data, diagnostic data, device data, results of each node in the wormhole, etc.) for later analysis. As time goes on, the unknown issues and support cases for the unknown issues may be resolved, e.g., by the support engineer, by the user, or by a partner engineer. If the support server encounters the same user device (e.g., another request for support is received) then the support server may check to see if the unknown issue remains. If the issue has been resolved, then the support server may determine the difference between the current diagnostic data from the user device and the previously saved diagnostic data when the issue was unresolved. The difference in diagnostic data may be saved as resolution data associated with that wormhole.

As time goes by, other devices may encounter the same issue and go through the same wormhole, which saves each support case and the difference in diagnostic data once the support case is resolved. In one example, each time the support server detects one of the support cases is solved, the support server compares the calculated difference of the newly resolved support case with the calculated difference saved for other resolved support cases. Once enough calculated differences from different support cases match, the support server determines that steps leading to that calculated difference is the resolution to the issue that was not previously covered by the wormhole, and the support server may automatically generate a new IC module to cover that issue based on the calculated difference. The new IC module is the basis for a new node in the decision tree of the wormhole. In other words, the support server operates a self-learning issue analysis engine that adapts resolved support cases to generate additional IC modules without dedicating the resources of an SME to write the new IC module.

In a specific example, the support server processes data from a user device with an application that is not updating properly. A wormhole associated with that issue (i.e., the application not updating properly) contains three nodes. First, the wormhole determines whether DNS lookup is enabled. After determining that DNS lookup is enabled, the wormhole determines whether the license for the application is valid. After determining that the license is valid, the wormhole determines whether the Uniform Resource Locator (URL) for obtaining application updates is valid. Once the three existing nodes of the wormhole are passed without finding the root cause, the support server saves the data from the support case as a new, unknown issue.

A few days later, the support server may process data from the same user device and detect that the application is updating properly. The support server calculates the difference in diagnostic data and determines that the dhe-aes128-sha1 Secure Sockets Layer (SSL) algorithm is specified in the saved diagnostic data for the support case (i.e., the non-working case), but that the dhe-aes128-sha1 SSL algorithm is not specified in the current diagnostic data (i.e., the working case). The support server determines that a predetermined number of other support cases (e.g., 49 other support cases) for this issue (i.e., the application is not updating properly) have been resolved with the same difference in diagnostic data. The support server adds a fourth node to the wormhole that detects that specific algorithm in the allowed SSL algorithms and a resolution is added to remove this restriction.

The support server may also notify support engineers or other administrators of the automatically added node to the wormhole, so that they may review and edit the machine generated content or further investigate the cause of the failure. In this instance, the administrators may determine that the update server for the application received a new certificate that disallowed that specific SSL algorithm, and any devices configured to use that SSL algorithm would fail to negotiate a connection to download the application update.

With the fourth node added to the wormhole, any new device that submits a support request for that application failing to update will also be checked by the new IC module that detects the SSL algorithms and removes the disallowed SSL algorithm. Additionally, any support cases that would have been resolved with the new IC module (e.g., the other 49 support cases with the same difference in diagnostic data) may be removed from consideration for other IC modules. In other words, support cases that were used to generate the new IC module are now associated with the new IC module, even though they were resolved before the new IC module was generated.

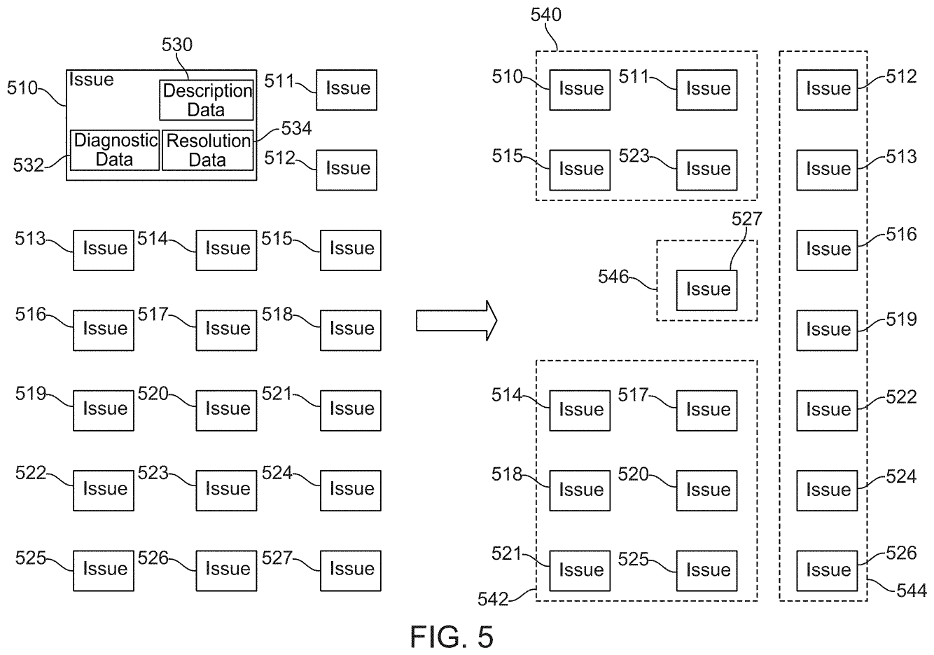

Referring now to FIG. 5, a simplified block diagram illustrates an example of clustering issue data to determine gaps in the coverage of IC modules. Instances of issue data 510-527 are shown in a grid for simplicity. Each issue data corresponds to a support case reporting an issue with a user device. The issue data 510 includes issue description data 530, diagnostic data 532, and resolution data 534. Each instance of issue data (e.g., issue data 511-527) includes similar issue description data, diagnostic data, and resolution data.

In one example, the issue description data 530 includes a text-based description of the issue, e.g., as provided by the user of the user device with the support request that initiated the support case associated with issue data 510. The issue description data 530 may also include records of communication (e.g., email, instant messages, notes from telephone calls) between the user reporting the issue and one or more support engineers tasked with resolving the issue. Additionally, the support engineer may directly input a text-based description of the issue into the issue description data 530.

In another example, the diagnostic data 532 may include configuration data (e.g., network settings, memory settings, application settings, system data, etc.) for the user device experiencing the issue. The diagnostic data 532 may be provided by the user device, derived by a support server, and/or obtained from a support engineer. In a further example, the resolution data 534 may include a summary of the resolution once the issue has been resolved. Additionally, the resolution data 534 may include instructions for remediating the issue when other user devices report the same issue. The resolution data 534 may also include an indication of one or more IC modules that were used in resolving the support case associated with the issue data 510.

A support server clusters the issue data 510-527 into issue groups based on the text similarity of the issue data. Issue data 510, 511, 515, and 523 are clustered into issue group 540. Issue data 514, 517, 518, 520, 521, and 525 are clustered into issue group 542. Issue data 512, 513, 516, 519, 522, 524, and 526 are clustered into issue group 544. In this example, the issue data 527 does not match any of the issue groups 540, 542, or 544, causing the issue data 527 to be the sole member of the issue group 546.

In one example, user descriptions and symptoms are stored as text-based representations of the issue being encountered and may be provided by the user with the support request. Throughout the life cycle of the support case, a more detailed rendition of the issue may be derived and documented by the support engineer. The support server uses these issue descriptions (e.g., issue description data 530) along with the resolution summaries (e.g., resolution data 534) as input into a text clustering algorithm (e.g., k-means) to generate issue groups. The clustering produces an automated grouping of support cases within a particular technology or product space.

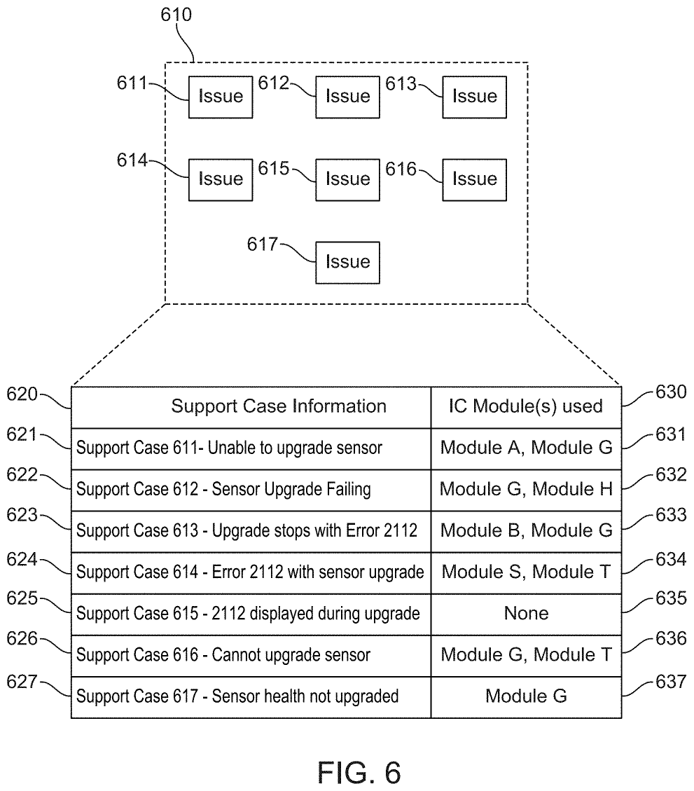

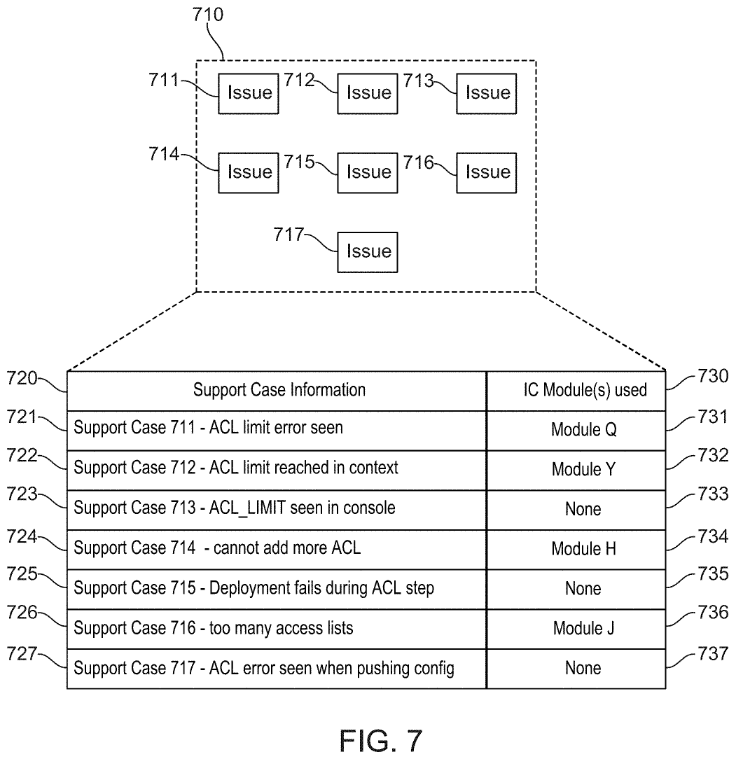

In another example, once the support server has generated issue groups of similar support cases, the support server may analyze the support cases to determine what issues were impacting the user device by examining the IC modules associated with each of the support cases in the issue group. By identifying if an IC module was used in the resolution of each support case, the support server may determine which IC modules, if any, are commonly used to solve the support cases of a particular issue group. If a particular IC module was used to resolve more than a predetermined percentage (e.g., 75%) of the support cases in an issue group, then the issue group is within the coverage of that particular IC module, as shown in FIG. 6. Conversely, for issue groups in which there is not a single IC module associated with at least the predetermined percentage of support cases, as shown in FIG. 7, the support server may determine that further analysis (e.g., by an SME) may generate a new IC module to cover the issue group.

Referring now to FIG. 6, a simplified block diagram illustrates an issue group 610 that is covered by an existing IC module. Issue group 610 includes issue data 611-617 that are associated with seven different support cases. The support server associates support case information 620 for each support case with the IC modules 630 used to resolve the corresponding support case. For instance, support case information 621 identifies the issue data 611 (e.g., described as “unable to upgrade sensor”) and is associated with the corresponding IC Module entry 631 (e.g., indicating Module A and Module G). Similarly, support case information 622 identifies the issue data 612 (e.g., described as “sensor upgrade failing”) and is associated with the corresponding IC Module entry 632 (e.g., indicating Module G and Module H).

Support case information 623 identifies the issue data 613 (e.g., described as “upgrade stops with error 2112”) and is associated with the corresponding IC Module entry 633 (e.g., indicating Module B and Module G). Support case information 624 identifies the issue data 614 (e.g., described as “error 2112 with sensor upgrade”) and is associated with the corresponding IC Module entry 634 (e.g., indicating Module S and Module T). Support case information 625 identifies the issue data 615 (e.g., described as “2112 displayed during upgrade”) and is associated with the corresponding IC Module entry 635, which indicates that no IC modules have been used to resolve the support case. Support case information 626 identifies the issue data 616 (e.g., described as “cannot upgrade sensor”) and is associated with the corresponding IC Module entry 636 (e.g., indicating Module G and Module T). Support case information 627 identifies the issue data 617 (e.g., described as “sensor health not upgraded”) and is associated with the corresponding IC Module entry 637 (e.g., indicating Module G).

In the example shown in FIG. 6, a significant majority (i.e., five of seven) of IC module entries indicate that Module G was used in the resolution of the support case. This indicates a strong relationship between the information provided in the IC Module G and the cluster of support cases in issue group 610. The support server infers that Module G covers the issue group 610, and there is no gap in IC coverage that needs attention from an SME.

Referring now to FIG. 7, a simplified block diagram illustrates an issue group 710 that is not covered by an existing IC module. Issue group 710 includes issue data 711-717 that are associated with seven different support cases. The support server associates support case information 720 for each support case with the IC modules 730 used to resolve the corresponding support case. For instance, support case information 721 identifies the issue data 711 (e.g., described as “Access Control List (ACL) limit error seen”) and is associated with the corresponding IC Module entry 731 (e.g., indicating Module Q). Similarly, support case information 722 identifies the issue data 712 (e.g., described as “ACL limit reached in context”) and is associated with the corresponding IC Module entry 732 (e.g., indicating Module Y).

Support case information 723 identifies the issue data 713 (e.g., described as “ACL_LIMIT seen in console”) and is associated with the corresponding IC Module entry 733 which indicates that no IC modules have been used to resolve the support case. Support case information 724 identifies the issue data 714 (e.g., described as “cannot add more ACL”) and is associated with the corresponding IC Module entry 734 (e.g., indicating Module H). Support case information 725 identifies the issue data 715 (e.g., described as “deployment fails during ACL step”) and is associated with the corresponding IC Module entry 735, which indicates that no IC modules have been used to resolve the support case. Support case information 726 identifies the issue data 716 (e.g., described as “too many access lists”) and is associated with the corresponding IC Module entry 736 (e.g., indicating Module J). Support case information 727 identifies the issue data 717 (e.g., described as “ACL error seen when pushing config”) and is associated with the corresponding IC Module entry 737, which indicates that no IC modules have been used to resolve the support case.

In the example shown in FIG. 7, the support server does not identify any consistent or IC module used to resolve support cases in the issue group 710. This represents a gap in the coverage of the existing IC modules, which may be addressed by notifying an SME of the potential gap in IC module coverage. The SME may investigate the collection of support cases in the issue group 710 and generate a new IC module that can detect the issue and provide remediation steps.

In another example, the support server may prioritize issue groups for SME attention based on varying parameters and settings. For instance, the support server may prioritize issue groups with more support cases over issue groups with fewer support cases. Additionally, the support server may prioritize issue groups with support cases that have a high impact on the operation of the user device. The support server may consider additional parameters, such as an explicit user priority setting (e.g., a user may indicate that issue groups related to a core business function are a higher priority than issue groups related to peripheral functions). The support server may also consider the length of time support cases have been outstanding when determining the priority of an issue group.

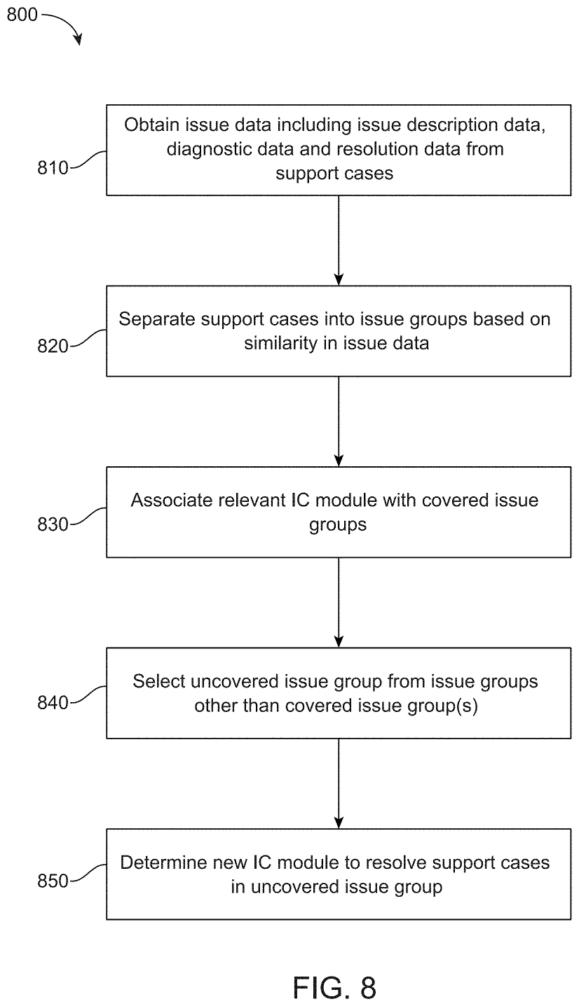

Referring now to FIG. 8, a flowchart illustrates operations performed by a support server (e.g., support server 130) in a process 800 to detect a gap in the coverage of existing IC modules and generate a new IC module to close the gap. At 810, the support server obtains issue data from a plurality of support cases. The issue data includes issue description data, diagnostic data, and resolution data for each support case. In one example, the issue data may include text based notations describing the issue in the support case and any resolution to the support case.

At 820, the support server separates the plurality of support cases into a plurality of issue groups based on a similarity in the issue data. In one example, the similarity in the issue data may be computed by clustering the text descriptions in the issue data with a k-means algorithm or other natural language processing algorithm. At 830, the support server associates a relevant IC module with one or more covered issue groups among the plurality of groups. In one example, the relevant IC module may be indicated in the issue data of a majority of support cases.

At 840, the support server selects an uncovered issue group from the plurality of issue groups other than the one or more covered issue groups. In one example, the support server may select the uncovered issue group based on a priority of the issue described in the support cases of the uncovered issue group. At 850, the support server determines a new IC module to resolve the support cases in the uncovered issue group. In one example, the support server may notify an SME who generates the new IC module. Alternatively, the support server may automatically generate the new IC module based on support cases that have been resolved within the issue group.

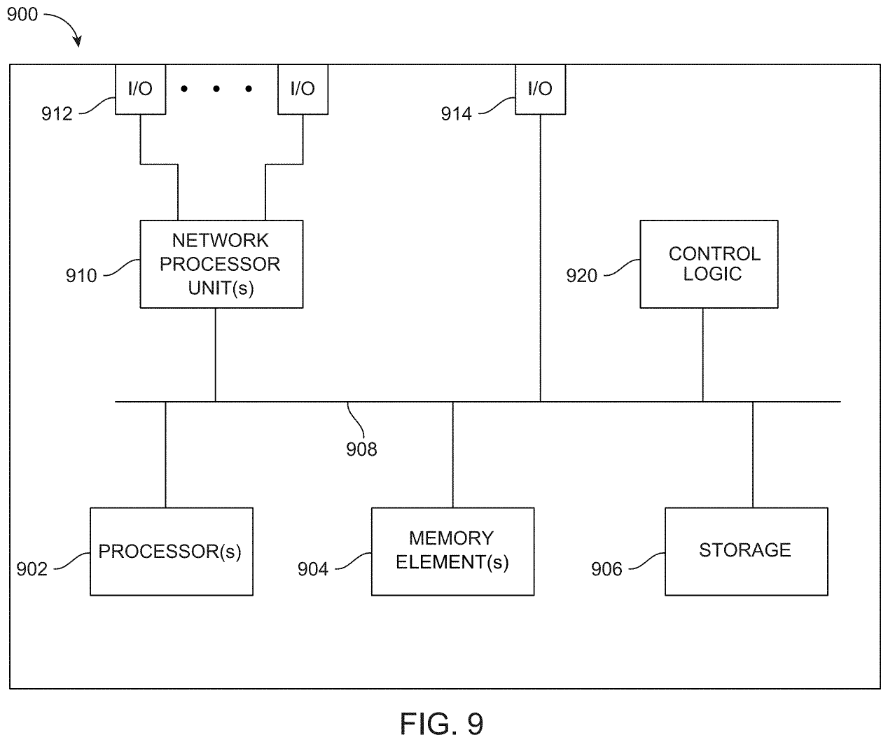

Referring to FIG. 9, FIG. 9 illustrates a hardware block diagram of a computing device 900 that may perform functions associated with operations discussed herein in connection with the techniques depicted in FIGS. 1-8. In various embodiments, a computing device, such as computing device 900 or any combination of computing devices 900, may be configured as any entity/entities as discussed for the techniques depicted in connection with FIGS. 1-8 in order to perform operations of the various techniques discussed herein.

In at least one embodiment, the computing device 900 may include one or more processor(s) 902, one or more memory element(s) 904, storage 906, a bus 908, one or more network processor unit(s) 910 interconnected with one or more network input/output (I/O) interface(s) 912, one or more I/O interface(s) 914, and control logic 920. In various embodiments, instructions associated with logic for computing device 900 can overlap in any manner and are not limited to the specific allocation of instructions and/or operations described herein.

In at least one embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory element(s) 904 (or vice versa), or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 910 may enable communication between computing device 900 and other systems, entities, etc., via network I/O interface(s) 912 to facilitate operations discussed for various embodiments described herein. In various embodiments, network processor unit(s) 910 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 912 can be configured as one or more Ethernet port(s), Fibre Channel ports, and/or any other I/O port(s) now known or hereafter developed. Thus, the network processor unit(s) 910 and/or network I/O interface(s) 912 may include suitable interfaces for receiving, transmitting, and/or otherwise communicating data and/or information in a network environment.

I/O interface(s) 914 allow for input and output of data and/or information with other entities that may be connected to computing device 900. For example, I/O interface(s) 914 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 920 can include instructions that, when executed, cause processor(s) 902 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 904 and/or storage 906 can store data, software, code, instructions (e.g., processor instructions), logic, parameters, combinations thereof, and/or the like used for operations described herein. This includes memory element(s) 904 and/or storage 906 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, entities for various embodiments described herein can encompass network elements (which can include virtualized network elements, functions, etc.) such as, for example, network appliances, forwarders, routers, servers, switches, gateways, bridges, load balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In summary, the techniques presented herein automates the identification of gaps in the coverage of existing IC modules by grouping common user problems and determining whether an existing IC module covers each group. If no IC module is indicated as relevant for a significant portion of support cases in a group, then an IC gap is indicated, and a new IC module may be written to identify the issue represented in the group and close the IC gap.

The support server may automatically generate a new IC module through the automatic grouping of unresolved issues. Those issues may be tracked to resolution and the differences between the unresolved state and the resolved state of the user devices may be compared. When the differences of a predetermined number of support cases have little to no variance, a new IC module may be generated that checks the pre-condition and presents the post-condition as a resolution to the issue. The new IC module may be automatically added to a wormhole for diagnosing future support cases, leading to a self-extending issue resolution system.

In one form, a method is provided for a support server to identify and close a gap in the coverage of existing IC modules. The method includes obtaining issue data from a plurality of support cases. The issue data from a particular support case (e.g., each particular support case) of the plurality of support cases includes issue description data, diagnostic data, and resolution data associated with the particular support case. The method also includes separating the plurality of support cases into a plurality of issue groups based on a similarity in the issue data. The method further includes associating a relevant IC module with one or more covered issue groups among the plurality of issue groups based on a majority of the support cases in the one or more issue groups including an indication of the relevant IC module in the issue data. The method also includes selecting an uncovered issue group from the plurality of issue groups other than the one or more covered issue groups and determining a new IC module to resolve support cases in the uncovered issue group.

In another form, an apparatus comprising a network interface and a processor is provided. The network interface is configured to communicate with one or more computing devices. The processor is coupled to the network interface, and configured to obtain issue data from a plurality of support cases. The issue data from a particular support case of the plurality of support cases includes issue description data, diagnostic data, and resolution data associated with the particular support case. The processor is also configured to separate the plurality of support cases into a plurality of issue groups based on a similarity in the issue data. The processor is further configured to associate a relevant IC module with one or more covered issue groups among the plurality of issue groups based on a majority of the support cases in the one or more issue groups including an indication of the relevant IC module in the issue data. The processor is also configured to select an uncovered issue group from the plurality of issue groups other than the one or more covered issue groups and determine a new IC module to resolve support cases in the uncovered issue group.

In still another form, a non-transitory computer readable storage media is provided that is encoded with instructions that, when executed by a processor of computing device, cause the processor to obtain issue data from a plurality of support cases. The issue data from a particular support case of the plurality of support cases includes issue description data, diagnostic data, and resolution data associated with the particular support case. The instructions also cause the processor to separate the plurality of support cases into a plurality of issue groups based on a similarity in the issue data. The instructions further cause the processor to associate a relevant IC module with one or more covered issue groups among the plurality of issue groups based on a majority of the support cases in the one or more issue groups including an indication of the relevant IC module in the issue data. The instructions also cause the processor to select an uncovered issue group from the plurality of issue groups other than the one or more covered issue groups and determine a new IC module to resolve support cases in the uncovered issue group.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims. For instance, the specific IEs described are used as examples of IEs that are currently defined in 3GPP specifications, but the techniques described herein may be adapted to other IEs that may be defined in current or future network specifications.

What is claimed is:

1. A method comprising:
obtaining issue data from a plurality of support cases, wherein the issue data from a particular support case of the plurality of support cases includes issue description data, diagnostic data, and resolution data associated with the particular support case;
separating the plurality of support cases into a plurality of issue groups based on a similarity in the issue data;
associating a relevant Intellectual Capital (IC) module with one or more covered issue groups among the plurality of issue groups based on a majority of support cases in the one or more covered issue groups including an indication of the relevant IC module in the issue data;
selecting an uncovered issue group from the plurality of issue groups other than the one or more covered issue groups; and
determining a new IC module to resolve support cases in the uncovered issue group.

2. The method of claim 1, wherein the issue description data of the particular support case includes records of communication between a user device and a support engineer device.

3. The method of claim 2, wherein separating the plurality of support cases into the plurality of issue groups is based on a similarity of text in the records of communication.

4. The method of claim 1, wherein determining the new IC module comprises:
notifying a computing device of a subject matter expert about the uncovered issue group;
providing the computing device of the subject matter expert with the issue data for the support cases in the uncovered issue group; and
obtaining the new IC module from the computing device of the subject matter expert.

5. The method of claim 1, wherein determining the new IC module comprises generating the new IC module automatically by analyzing the issue data for the support cases in the uncovered issue group.

6. The method of claim 5, wherein analyzing the issue data for the support cases in the uncovered issue group comprises determining a difference in issue data for resolved support cases in the uncovered issue group from issue data for unresolved support cases in the uncovered issue group.

7. The method of claim 1, wherein the issue description data associated with the particular support case includes text submitted by a user device, the diagnostic data includes one or more potentially relevant IC modules, and the resolution data includes text submitted by a support engineer device.

8. An apparatus comprising:
a network interface configured to communicate with one or more computing device; and
a processor coupled to the network interface, the processor configured to:
obtain issue data via the network interface from a plurality of support cases, wherein the issue data from a particular support case of the plurality of support cases includes issue description data, diagnostic data, and resolution data associated with the particular support case;
separate the plurality of support cases into a plurality of issue groups based on a similarity in the issue data;
associate a relevant Intellectual Capital (IC) module with one or more covered issue groups among the plurality of issue groups based on a majority of support cases in the one or more covered issue groups including an indication of the relevant IC module in the issue data;
select an uncovered issue group from the plurality of issue groups other than the one or more covered issue groups; and
determine a new IC module to resolve support cases in the uncovered issue group.

9. The apparatus of claim 8, wherein the issue description data of the particular support case includes records of communication between a user device and a support engineer device.

10. The apparatus of claim 9, wherein the processor is configured to separate the plurality of support cases into the plurality of issue groups based on a similarity of text in the records of communication.

11. The apparatus of claim 8, wherein the processor is configured to determine the new IC module by:
causing the network interface to notify a computing device of a subject matter expert about the uncovered issue group;
cause the network interface to provide the computing device of the subject matter expert with the issue data for the support cases in the uncovered issue group; and
obtaining the new IC module from the computing device of the subject matter expert via the network interface.

12. The apparatus of claim 8, wherein the processor is configured to determine the new IC module by generating the new IC module automatically by analyzing the issue data for the support cases in the uncovered issue group.

13. The apparatus of claim 12, wherein the processor is configured to analyze the issue data for the support cases in the uncovered issue group by determining a difference in issue data for resolved support cases in the uncovered issue group from issue data for unresolved support cases in the uncovered issue group.

14. One or more non-transitory computer readable storage media encoded with software comprising computer executable instructions and, when the software is executed on a processor of a support server, operable to cause a processor to:
obtain issue data from a plurality of support cases, wherein the issue data from a particular support case of the plurality of support cases includes issue description data, diagnostic data, and resolution data associated with the particular support case;
separate the plurality of support cases into a plurality of issue groups based on a similarity in the issue data;
associate a relevant Intellectual Capital (IC) module with one or more covered issue groups among the plurality of issue groups based on a majority of support cases in the one or more covered issue groups including an indication of the relevant IC module in the issue data;
select an uncovered issue group from the plurality of issue groups other than the one or more covered issue groups; and
determine a new IC module to resolve support cases in the uncovered issue group.

15. The one or more non-transitory computer readable storage media of claim 14, wherein the issue description data of the particular support case includes records of communication between a user device and a support engineer device.

16. The one or more non-transitory computer readable storage media of claim 15, wherein the software is further operable to cause the processor to separate the plurality of support cases into the plurality of issue groups based on a similarity of text in the records of communication.

17. The one or more non-transitory computer readable storage media of claim 14, wherein the software is further operable to cause the processor to determine the new IC module by:
notifying a computing device of a subject matter expert about the uncovered issue group;
providing the computing device of the subject matter expert with the issue data for the support cases in the uncovered issue group; and
obtaining the new IC module from the computing device of the subject matter expert.

18. The one or more non-transitory computer readable storage media of claim 14, wherein the software is further operable to cause the processor to determine the new IC module by generating the new IC module automatically by analyzing the issue data for the support cases in the uncovered issue group.

19. The one or more non-transitory computer readable storage media of claim 18, wherein the software is further operable to cause the processor to analyze the issue data for the support cases in the uncovered issue group by determining a difference in issue data for resolved support cases in the uncovered issue group from issue data for unresolved support cases in the uncovered issue group.

20. The one or more non-transitory computer readable storage media of claim 14, wherein the issue description data associated with the particular support case includes text submitted by a user device, the diagnostic data includes one or more potentially relevant IC modules, and the resolution data includes text submitted by a support engineer device.
